(19) United States
(12) Patent Application Publication
(10) Pub. No.: US 2025/0367752 A1
(43) Pub. Date: Dec. 4, 2025

(54) GAS CLUSTER ION BEAM APPARATUS

(71) Applicant: IIPT Inc., Sagamihara-shi (JP)

(72) Inventors: Katsumi Tokiguchi, Sagamihara-shi (JP); Izumi Kataoka, Sagamihara-shi (JP); Katsumi Hanazono, Sagamihara-shi (JP); Katsutoshi Tsuchiya, Sagamihara-shi (JP)

(21) Appl. No.: 19/216,906

(22) Filed: May 23, 2025

(30) Foreign Application Priority Data
May 31, 2024 (JP) 2024-088699

(51) Int. Cl. B23K 15/02; B23K 15/06; B23K 15/08

(52) U.S. Cl. CPC B23K 15/02; B23K 15/06; B23K 15/08

(57) ABSTRACT

In order to provide a gas cluster ion beam apparatus that can perform unprecedented high accuracy trimming processing by generating a high speed and high accuracy pulse beam and adjusting a pulse width and a pulse cycle etc. thereof, a switching circuit including a switching device 32 arranged in a power supply line supplying a voltage to an ionizer 5 and an anode rod 17 with equal potential to the ionizer from an ionizing power supply 30 for accelerating ionizing thermal electrons of the ionizer 5 is provided. A gas cluster ion beam can be intermittently irradiated onto the irradiated substrate 15 by which the switching circuit SWC controls turning on and off of the switching device 32.

### TECHNICAL FIELD

The present invention relates to a gas cluster ion beam apparatus, in particular, the gas cluster ion beam apparatus to suitably perform an advanced surface treatment for various material substrates, etc. using a gas cluster ion beam.

### BACKGROUND ART

Patent Document 1 and Patent Document 2 disclose a conventional gas cluster ion beam apparatus (hereinafter sometimes referred to as the GCIB apparatus) for a surface processing treatment of a substrate that ionizes a gas cluster beam by electron impacting in an ionizer, extracts generated gas cluster ions as a beam by using an extraction electrode extracting the gas cluster ion from the ionizer, transports the beam to an irradiation chamber by using one or more electrostatic lenses or the like and irradiates the beam onto the substrate disposed in the irradiation chamber. The surface treatment for various material substrates by using a gas cluster ion beam is performed for not only a treatment of a substrate itself (a surface smoothing process, etc.) but also a process for adjusting the thickness of a film deposited on a substrate (as called etching, trimming, etc.). In general, an irradiated ion beam is a DC beam with a constant current value.

Patent Document 3 discloses an example of a gas cluster ion beam apparatus for obtaining a uniform film thickness by which an irradiation to an entire surface of a substrate is performed with a mechanical movement of the substrate in a vacuum and by which mechanical movement speed of the substrate is varied corresponding to the thickness of the substrate. In particular, Patent Document 3 discloses an example of a gas cluster ion beam apparatus for allowing very fine trimming. In order to achieve a smaller trimming amount than that obtained at the limit of the mechanical movement speed, a pulse beam with a fixed time width can be irradiated only when the speed of the drive mechanism approaches the limit thereof.

In addition, Patent Document 4 discloses an ion beam apparatus that performs uniform processing distribution and trimming by a combination which the beam is extracted in pulses to perform high-precision surface processing on various material substrates by using an ion beam of normal single atom or molecule except gas cluster ions and the mechanical movement speed on the substrate is controlled according to the amount of trimming required at each point on the substrate.

### PRIOR ART DOCUMENTS

### Patent Documents

Patent Document 1: International Publication No. 2023248856A1 (Dec. 28, 2023)
Patent Document 2: Japan Patent No. 4,902,088 (Jan. 29, 2002)
Patent Document 3: Japan Patent No. 7,078,632 (Jan. 30, 2020)
Patent Document 4: Japan Published Patent Application No. 2006-344931 (Dec. 21, 2006).

### Non-Patent Document

Non-Patent Document 1: Materials processing by cluster ion beams (Isao Yamada, 2015, CRC Press)

### SUMMARY OF INVENTION

### Technical Problem

Gas cluster ions being in a case that surface processing of material substrates (hereinafter, referred to as etching, trimming, etc.) by using a gas cluster ion beam is performed are ionized neutral cluster particles formed by condensation of several hundred to several thousand atoms or molecules. The gas cluster ions are generated by which a neutral cluster beam extracted from a cluster generation chamber generating the neutral cluster particles is introduced into an ionizer and by which electrons are accelerated and impacted with the neutral cluster beam to ionize the neutral cluster beam. Furthermore, high voltage (several kV to several 10 kV) is applied to the ionizer, the gas cluster ions are extracted as an ion beam from the ionizer by using an extraction electrode or the like, then the ion beam is introduced into an irradiation chamber having an irradiated substrate therein and etching or trimming etc. is performed by which the ion beam is irradiated onto the irradiated substrate. The term “trimming” used here is defined as irradiation processing for smoothing out uneven thickness of a thin film formed on a substrate surface. The kinetic energy of the gas cluster ions irradiated onto the substrate is equal to the accumulation value of the charge number of the ions and the high voltage applied to the ionizer. Thereby, the gas cluster ion beam having the significantly high kinetic energy is obtained. The ion beam is normally extracted by a high voltage of approximately several kV to 60 kV. Gas clusters are dissociated upon collision with the surface when the gas cluster ion beam mentioned above strikes the material substrate. Average kinetic energy of each dissociated atom/molecule is approximately equal to the energy of the original gas cluster ions divided by the number of clusters (called as the cluster size). Therefore, the energy of each particle (atom or molecule) is approximately several 10 eV so that it is known that a large number of dissociated particles with such an energy move laterally across the surface of the substrate, and etching or trimming the surface of the substrate and smoothing out the unevenness are performed (Non-Patent Document 1). In comparison with the collision energy of several hundreds to several thousands of V in an ion beam processing apparatus (Patent Document 4) that ionizes a normal single atom to obtain a beam, the energy of which the gas cluster ion beam has after collision with the substrate is significantly small. Consequently, the gas cluster ion beam has the advantage that trimming processing can be efficiently performed while smoothing the surface without damaging the surface of the substrate. The processing speed is increased with increasing gas cluster ion beam amount and beam energy. In recent years, in order to increase the processing speed, a demand for increasing the beam energy without compromising the low damage effect is required. In particular, a demand to increase the energy of gas cluster ions from the conventional 10 to 30 kV to 60 kV or more is required.

On the other hand, beam irradiation onto the material substrate is performed by which a stage having the irradiated substrate thereon is mechanically moved with keeping the gas cluster ion beam stationary. By the movement of the stage, a common method is that the beam irradiates on the entire surface of the substrate such as to irradiate the beam only at the desired location or to move the stage back and forth in two dimensions in the X and Y directions. In particular, in an irradiation for aiming at trimming, a single-wafer irradiation is performed in which substrates are irradiated one by one.

In recent years, a gas cluster ion beam (hereinafter, sometimes abbreviated as GCIB) of 30 kV or more has been started to be used in order to quickly adjust (trimming) the thickness of a film deposited on a surface of a substrate and to increase the throughput of the trimming process. In particular, for substrates with non-uniform film formation, thickness correction irradiation that makes the film thickness uniform for the substrates with non-uniform film formation and GCIB irradiation that creates substrates with appropriate film thickness gradients have been performed. In order to realize such irradiation processing mentioned above, for a stationary GCIB with a value of constant current, the substrate positioned on a stage has been moved at a speed that is variable depending on the film thickness distribution to remove the film. In areas where the film is thick, the moving speed is slowed down to lengthen the residence time of the beam and increase the amount of trimming. On the other hand, in areas where the film is thin, the moving speed is increased to reduce the amount of trimming. That is, the beam dwell time at each point on the surface of the substrate is changed for each location to obtain a desired flat distribution of the film thickness (Patent Documents 3 and 4).

Furthermore, in recent years, the film thickness itself formed on a substrate is also becoming thinner, thereby in order to smooth out the unevenness of the film thickness, there has been a particular demand for removing a minute amount of film thickness (trimming) at high speed and with high accuracy. In order to correspond to the demand mentioned above, a mechanical stage moving mechanism that the stage having a sample thereon is varied in vacuum from a low speed (several mm/sec.) to a high speed (several hundreds of mm/sec.) range. Large motors and complex drive conversions are required to be quickly processed for which heavy objects such as stages are moved in a vacuum at high speed and with high precision and reverse movement at turning points is smoothly performed, therefore, the maximum speed that can be practically used is about several hundreds of mm/sec. As a result, the minimum trimming amount is determined by the maximum value of mechanical scanning speed.

In addition, a region close to the desired film thickness may have been already obtained in a part of the surface as an irradiated substrate. In the case mentioned above, moving of the substrate with an extremely high speed is required in the region close to the desired film thickness of the substrate. However, there is a limit to the maximum speed of the substrate that can be obtained so that there has been a limit to the minimum trimming amount.

By the way, a practical irradiation is performed by the following process. Firstly, surface film thickness distribution of an irradiated substrate is measured in advance. Secondly, with respect to a beam to be used, the distribution of the amount of removable (trimming) per unit time of stationary beam irradiation is measured. Further, the sum of the beam residence times (dwell times) at each point on the surface of the sample is calculated for obtaining the desired amount of material removed at each point on the surface of the sample. Next, stage speed at each point on the surface of the sample is calculated so as to obtain the beam residence time at each point on the surface of the sample. To obtain data on the speed change of the stage, the movement speed of the substrate is calculated to obtain the desired amount of material removed by multiple round trips of the irradiated substrate. There are various programs available for calculating velocity distributions. Hereinafter, such a beam irradiation method explained above will be referred to as dwell time controlled irradiation.

As including the dwell time controlled irradiation mentioned above, in conventional gas cluster ion beam irradiation processing, a gas cluster ion beam is a DC beam and the value of current of the DC beam is maintained constant. In a conventional dwell time controlled irradiation, a minimum amount of a material removed is determined by a maximum moving speed of a substrate, and it has been difficult to obtain a better amount of a material removed about zero or a value close to zero. Therefore, in order to compensate micro-trimming even if being in a limit of mechanical speed characteristics, an ion beam, which is usually extracted as a direct current beam, is converted into a rectangular pulse beam only when the machine is approaching the maximum designed mechanical scanning speed, and an idea for compensation of micro-trimming was made by adjusting a duty (number of pulses per unit time) of an irradiated pulse beam (Patent Document 3). In the case mentioned above, an amount of a material removed is adjusted by changing only a repeated cycle (a duty cycle, a time interval between a pulse and a next pulse) with constant width of a beam pulse. Patent Document 3 discloses that intermittent shutdown of electron beam delivery for ionization in the ionizer to generate gas cluster ions was sufficient for pulsing. Patent Document 3, however, does not disclose any ideas for the specific configuration to achieve the thought mentioned above and any switching function.

On the other hand, Patent Document 4 discloses that the pulsing of an extracted ion beam is achieved by which the voltage of an ion extraction electrode itself is turned on and off in an ionizer extracting a single atom ion beam at conventional 200 eV to 2 keV which is not a gas cluster ion beam. However, in case of the ionizer extracting an ion beam from plasma as the ionizer disclosed in Patent Document 4, it is difficult to obtain a predetermined pulse beam by which the ion beam is generated at a high voltage of several tens of kV with rise and fall times of not more than a millisecond. This is because it takes a millisecond or more to form a suitable plasma boundary for extracting ions.

As described above, in practical irradiation, the irradiated substrate may be crossed by the beam multiple times. Typically, the stage must be moved in a boustrophedonic or zigzag fashion relative to a residence beam in order to irradiate a beam onto the entire surface (including both uniform and non-uniform) of a sample (round wafers, etc.). In the case mentioned above, the stage is moved so that the beam is sufficiently directed outside the sample (as is called over scanning) at the periphery of the sample since the beam has a limited size. In case of a sample of which the amount of removing around the outer periphery of the sample is required to be significantly small, the maximum moving speed was required at the periphery of the sample in the conventional example. In addition, in order to smoothly turn around after breaking through, it was also required to increase the distance breaking through the sample and to smoothly switch to the opposite direction of the movement. Therefore, there was a problem that the time not contributing to the irradiation onto a substrate itself was increased and was also a problem that the sample processing capacity (throughput) was decreased. In addition, the current value of the irradiation had to be reduced in an apparatus for the dwell time controlled irradiation since the amount of material removed at the maximum possible mechanical movement speed tends to be reduced. A decrease in the current value leads to a problem of a decrease in throughput.

The minimum amount of material removed had a limit determined by the maximum mechanical movement speed in the trimming processing using the GCIB apparatus for mechanical sample moving and the subject was to develop an irradiation technique that would reduce the minimum amount of material removed without reducing the value of the irradiation current. In particular, since the etching speed of the material in general is dramatically increased in GCIB high energy irradiations over 30 keV as required in recent years, the subject was to develop an irradiation technique that would be high accuracy and high throughput for those irradiations mentioned above.

As explained above, it has been generally difficult to do high-speed switching of high voltages in a conventional gas cluster ion beam apparatus extracting a beam under high voltages, and also difficult to stably obtain a pulsed beam with short rise and fall times. Consequently, it has not been possible to perform trimming that would allow for highly accurate film thickness adjustment.

An object of the present invention is to provide a gas cluster ion beam apparatus that enables unprecedented high accuracy trimming processing by generating a high speed and high accuracy pulse beam and adjust a pulse width and a pulse cycle etc. thereof, even in the case of extracting a beam under high voltages.

Another object of the present invention is to provide a gas cluster ion beam (GCIB) apparatus that obtains desired film thickness distribution by controlling the beam residence time at each point on the substrate by changing the mechanical scanning speed of the stage carrying the substrate, thereby changing an amount of a material removed (an amount of trimming) of a film on the surface of the irradiated substrate.

Further another object of the present invention is to provide a gas cluster ion beam (GCIB) apparatus that accurately obtains a removal amount value equal to or less the minimum removal amount of film (including zero) determined by the maximum value of the mechanical scanning speed.

### Solution to Problem

For easier understandings, the following explanations will use the same reference numerals as the reference numerals used in the figures of the present invention. However, the descriptions of the reference numerals should not be used to interpret the present invention as being limited to the embodiments.

A gas cluster ion beam apparatus of the present invention includes a high voltage power supply 22a that generates a positive high voltage Va, a cluster generation chamber 1 that generates a neutral gas cluster beam of gas atoms or gas molecules by injecting high-pressure gas through a nozzle 3 in a vacuum, a skimmer 4 that skims a cluster beam from a central region in the neutral gas cluster beam, an ionizer 5 that generates cluster ions and a beam transport system that irradiates the gas cluster ion beam onto an irradiated substrate 15 placed in a vacuum vessel for an irradiation chamber 12.

The ionizer 5 includes a thermal filament 16 generating ionizing thermal electrons and an anode rod 17 to which an electron acceleration voltage Vi is applied to accelerate the ionizing thermal electrons in a conductive housing 51 to which the positive high voltage is applied and generates cluster ions by impacting ionization of the ionizing thermal electrons to be accelerated with the cluster beam introduced into the conductive housing 51 through the skimmer 4. In addition, the beam transport system extracts the cluster ions from the ionizer 5 as a gas cluster ion beam by a potential difference between an acceleration electrode 6 provided at an outlet of the conductive housing 51 and to which the positive high voltage is applied and an extraction electrode 7 provided downstream of the acceleration electrode 6, and irradiates the gas cluster ion beam onto an irradiated substrate 15 placed in a vacuum vessel for an irradiation chamber 12 through one or more electrostatic lenses to which the positive high voltage is applied from the high voltage power supply.

In addition to the configuration explained above, the present invention also includes a high voltage stage 31 being in a state to which the positive high voltage Va is applied and including a thermal filament power supply 29 that supplies a heating current to the thermal filament 16 and an ionizing power supply 30 that applies the electron acceleration voltage Vi to the anode rod 17 to which the positive high voltage Va is applied, and a switching circuit SWC including a switching device 32 provided in a power supply line between the ionizing power supply 30 and the anode rod 17. The gas cluster ion beam 11 can be intermittently irradiated onto the irradiated substrate 15 by which the switching circuit SWC controls the switching device 32 to be turned on and off.

According to the present invention, when a DC gas cluster ion beam extracted from the ionizer 5 by using the extraction electrode 7 is generated, the electron acceleration voltage Vi applied from the ionizing power supply 30 arranged in the high voltage stage 31 to the anode rod 17 positioned in the ionizer 5 is made pulsed by turning on and off the switching device 32 arranged in the high voltage stage 31. The voltage value of the electron acceleration voltage Vi is lower (in the example level, the voltage is 1/100 or less) than the voltage of the positive high voltage Va. Therefore, there is no electrical noise that would occur if the switching element 32 were switched at a high voltage, and there is no effect on other equipment or electrical elements. In addition, since a solid-state semiconductor element can be used as the switching element 32, the switching element 32 can be switched at high speed. As a result, according to the present invention, a pulsed beam with short rise and fall times can be obtained stably. As a further result, according to the present invention, unprecedented high accuracy trimming processing by generating a high speed and high accuracy GCIB pulse beam and adjusting a pulse width and a pulse cycle etc. thereof can be performed.

The switching device 32 is able to include a high voltage FET (Field Effect Transistor) connected to an output line of the ionizing power supply 30. In addition, the switching circuit SWC includes a transmitting and receiving module comprising an optical receiver member 33 and an optical transmitter member 34 connected by an optical fiber, and the transmitting and receiving module are provided between a pulse generator 35 that generates an on/off pulse signals and the switching device 32. With this configuration, switching (optical switching) can be performed through an optical cable that is an electrical insulator to perform a switching function even if the switching device 32 of the switching circuit SWC is housed in the high voltage stage 31 having the same potential as the acceleration electrode 6 or the ionizer 5. Therefore, controlling of pulse generation can be easily performed by any equipment at the ground potential.

According to the specific embodiment of the present invention, providing the switching circuit, for samples where a portion of the sample surface of the irradiated substrate already has a desired film thickness, it is possible to turn off the irradiation of the gas cluster ion beam at the portion where the desired film thickness is achieved, and turn on the irradiation of the gas cluster ion beam by mechanical movement with a speed variable with the film thickness at the portion where the desired film thickness is not achieved. By providing a switching circuit to turn the gas cluster ion beam on and off with rise and fall times of less than a millisecond, highly accurate beam pulsing can be achieved, making it possible to perform highly accurate trimming processing not only in dwell (time) controlled irradiation, but also in irradiation with a constant mechanical scanning speed.

As the switching device 32, FET (Field Effect Transistor) can be used. The switching device 32 is provided in the high voltage stage. In addition, the switching circuit SWC may include the transmitting and receiving module comprising the optical transmitter member 34 and the optical receiver member 33 both connected by the optical fiber (the optical cable 36) between the pulse generator 35 generating a pulse signal for on/off switching and the switching device 32. Note that the optical receiver member 33 may comprise ROSA (Receiver Optical SubAssembly), and the optical transmitter member 34 may comprise TOSA (Transmitter Optical SubAssembly). In particular, the signal sent from general-purpose ROSA used as the optical receiver member 33 is supplied as a switching voltage of the FET explained above. On the other hand, the ROSA receives an optical signal sent from the TOSA as the optical transmitter member 34 at the ground side through the optical cable 36. The TOSA converts the pulse signal to be inputted into an optical switch signal. By using the switching circuit SWC with the optical cable in this manner, an electrical short circuit will not occur between the optical cable and the high-voltage table since the optical cable is an electrical insulator and, unlike ordinary electric cables, does not contain metal materials such as copper wires. Therefore, a signal can be stably sent from a member being at a ground potential. Thereby, the switching of the FET explained above allows a variety of pulse waveform to be easily selected since a pulse waveform generator of general-purpose various specifications (a waveform, a period, a pulse rise time, etc.) being at the ground potential can be chosen as a signal generator sending a switching signal. Accordingly, any pulse waveform can be easily and safely obtained for the gas cluster ion beam. Therefore, there is an advantage that the trimming can be easily performed by pulse controlling corresponding to the film thickness distribution on the irradiated substrate. In addition, when an irradiation substrate stage 14 is moved, the switching is kept on until midway to perform irradiation with a DC beam, and by turning the switching off at an arbitrary stage position, the DC irradiation beam can be easily cut off at high speed.

Furthermore, as switching at an output line OL of the ionizing power supply 30, MOS (Metal Oxide Silicon)—FET (Field Effect Transmitter) for high voltages may be used.

Thereby, a constant voltage square pulse having a characteristic that an ionizing voltage for accelerating ionizing thermal electrons and ionizing therefor rises and falls within quite a short time can be supplied and a pulse beam that rises and falls within a short time can be formed. Consequently, trimming controlling with a width of an element unit by patterning onto the irradiated substrate can be performed.

Furthermore, specifically, in the case that the switching circuit SWC includes a pulse generator 35 that generates square pulses to control the switching device 32 to be turned on and off, the switching circuit SWC further includes a motor drive controller 28 that drives and controls a motor 27 that drives a stage for irradiated substrate 14 mounting the irradiated substrate 15 and a pulse generator controller 37 that controls output timing of the pulses output from the pulse generator 35 based on both position and mechanical movement speed of the irradiated substrate 15 obtained by the motor drive controller 28. Consequently, the irradiation beam can be irradiated only onto the targeted position of the irradiated substrate. In addition, the partial trimming correcting only the remained portion where trimming was insufficient and the film thickness remained too thick even after trimming.

Note that the pulse generator controller 37 controls the pulse generator 35 in accordance with the movement of the irradiation substrate 15 so that the gas cluster ion beam is irradiated only onto a region of a determined thickness, thereby obtaining an arbitrary thickness distribution, when the film thickness distribution is adjusted by removing the film by irradiating the gas cluster ion beam after measuring the film thickness distribution of the irradiated substrate 15 on which a film made of a material different from the substrate has been deposited. That is, the irradiation time is controlled so that an ionizing voltage pulse width of the ionizer 5 is shortened for a thin portion of the film on the irradiation substrate 15, and the pulse width is lengthened for a thick portion of the film on the irradiation substrate 15. The amount of trimming is proportional to the pulse width of the irradiation current pulse. Therefore, if the irradiation current pulse having a long width is used, there will be no non-irradiated region in the irradiated portion so that the effective amount of trimming will increase. Therefore, irradiation time is reduced and processing throughput (processing capacity per unit time) is improved in comparing to the case that the irradiation is performed using the pulses with same pulse width.

The pulse generator 35 is configured to generate square pulses, and the pulse generator controller 37 changes a pulse width and a pulse interval of square gas cluster ion beam pulses generated by the square pulses (changing with a pulse width and a pulse interval using a pulse width modulation) depending on the position and velocity of the irradiated substrate 15 as the irradiated substrate 15 is mechanically moved, thereby making it possible to adjust the film thickness distribution of the irradiated substrate 15 to any shape.

The pulse generator controller 37 may be configured to obtain a purposed film thickness distribution by which a frequency of a repetitive pulses is modulated in proportion to the thickness of the film, with the movement of the irradiated substrate 15. That is, the pulse width of the ionization voltage applied to the ionizer 5 may be shortened to form a high repetition pulse, and the number of constant pulses applied per unit time (frequency) may be modulated (so-called pulse code modulation) depending on the amount to be trimmed. Consequently, high-accuracy trimming processing is possible.

Note that if the switching is performed by repeating pulses with short pulse width, the total time of the irradiated time at each location of the irradiated substrate 15 may be adjusted by which a reputation cycle of the pulses is increased at an area where the film is thinner and the reputation cycle of the pulses is decreased at an area where the film is thicker. Consequently, the uniform trimming processing is possible.

The irradiated substrate 15 may be mechanically moved with constant velocity, and the mechanical movement speed of the irradiated substrate 15 is varied with a position and a film thickness on the irradiated substrate 15.

### BRIEF DESCRIPTION OF DRAWINGS

FIG. 1 is a diagram used to explain the configuration of a GCIB apparatus previously developed by the inventors, which is the subject of improvement of the present invention.

FIG. 2 is a diagram used to explain the configuration of an ionizer and the power supply arrangement thereof in the configuration of the GCIB apparatus previously developed by the inventors, which is the subject of improvement of the present invention.

FIG. 3 is a diagram used to explain the configuration of a switching circuit in the pulsing device provided in the GCIB apparatus of the present invention and the power supply type applying to the ionizer.

FIG. 4 is a diagram used to explain a pulse waveform (part A) sent from the waveform generator to the switching circuit provided in the pulsing device as illustrated in FIG. 3 and a pulse waveform (part B) of the GCIB current irradiated onto the irradiated substrate thereby.

FIG. 5 is a diagram illustrating a configuration of the apparatus including the switching circuit used for actual trimming an irradiated substrate by using the gas cluster ion beam apparatus having the switching circuit of the present embodiment.

FIG. 6 is a diagram used to explain the relationship between the film thickness distribution position when performing the film thickness distribution adjustment and the beam current of the irradiation beam based on the actual film thickness distribution adjustment for a thermal oxide film on a silicon sample substrate by using the gas cluster ion beam apparatus including the switching circuit of the configuration illustrated in FIG. 5. FIG. 6 is also a diagram used to explain an example of the irradiation to be performed.

FIG. 7 is a diagram used to explain an example of the irradiation to be performed based on the embodiment of the present invention.

FIG. 8 is a diagram used to explain an example of the irradiation to be performed based on another embodiment of the present invention.

### DETAILED DESCRIPTION OF THE EMBODIMENTS

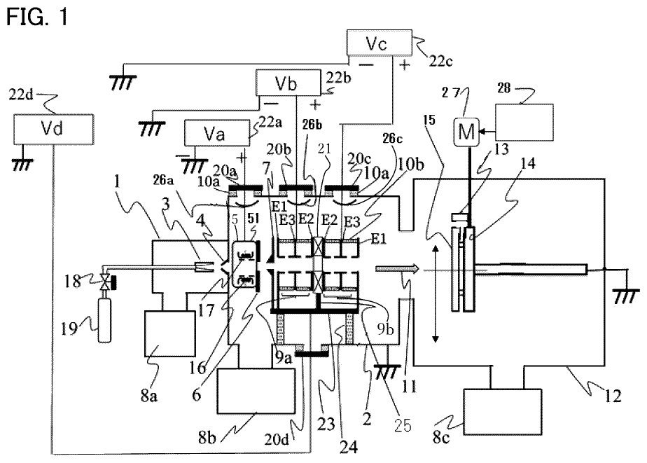

FIG. 1 is a diagram used to explain the configuration of a gas cluster ion beam apparatus (GCIB apparatus) previously developed by the inventors of the present invention, which is the subject of improvement of the present invention. In FIG. 1, 1 denotes a cluster generation chamber, 2 denotes a vacuum vessel, 3 denotes a nozzle, 4 denotes a skimmer, 5 denotes an ionizer, 6 denotes an acceleration electrode, 7 denotes an extraction electrode, 8a, 8b and 8c denote vacuum exhaust pumps, 9a and 9b denote first and second electrostatic lenses, 12 denotes a vacuum vessel for an irradiation chamber, 13 denotes a Faraday cup, 14 denotes a stage for an irradiated substrate, 15 denotes an irradiated substrate, 16 demotes a thermal filament comprising tungsten, 17 denotes an anode rod, 19 denotes a high-pressure gas cylinder, 21 denotes a permanent magnet type magnet and 22a, 22b and 22c denote first high voltage power supply, second high voltage power supply and third high voltage power supply.

In the GCIB apparatus which is the subject of improvement illustrated in FIG. 1, condensation of atoms and molecules occurs due to adiabatic expansion so that a neutral gas cluster beam is formed when a gas which is introduced from the high-pressure gas cylinder 19 to the nozzle 3 is ejected from the nozzle 3. Thereafter, only the neutral gas cluster beam that is high-density and is positioned at the center portion of the neutral gas cluster beam is skimmed as a cluster beam by the skimmer 4 and then introduced into the ionizer 5. In the ionizer 5, ionizing thermal electrons generated from the thermal filament comprising tungsten 16 located in a conductive housing 51 are accelerated to several hundreds of eV by a DC voltage applied to the anode rod 17, and are collided with the neutral cluster beam for ionization. The potential of the ionizer 5 is a same potential of the DC voltage applied to the anode rod 17. Consequently, the neutral cluster beam is efficiently ionized. A hot filament power supply 29 is used for heating the thermal filament 16, and an ionizing DC power supply 30 is used for applying a positive DC voltage to the anode rod 17. In FIG. 1, the illustration of these power supplies explained above are omitted.

In addition, a voltage of several tens of kV (illustrated in FIG. 1 as Va) generated from the first high voltage power supply 22a is applied to the acceleration electrode 6 through a high voltage introduction flange 20a, and the cluster ions are extracted as an ion beam from the ionizer 5 due to the voltage difference (=the electric field strength) between the voltage of the acceleration electrode 6 and the voltage of the extraction electrode 7. Then, the ion beam is transported to the irradiation substrate 15 positioned in the vacuum vessel for an irradiation chamber 12 by which a beam transport system including the first and second electrostatic lenses 9a and 9b in two stages as a beam transport system is used. Control of the beam shape and beam transport with little current loss are realized by adjusting the voltages Vb and Vc of the electrostatic lenses 9a and 9b. The first electrostatic lens 9a and the second electrostatic lens 9b have a cylindrical electrode E1 and a cylindrical electrode E2 at both ends of the lenses, respectively, a bias voltage Vd which is a positive high voltage generated from a separated high voltage power supply 22d as a bias power supply is applied to both the cylindrical electrode E1 and the cylindrical electrode E2. The extraction electrode 7 and the cylindrical electrode E1 are at the same potential. A positive high voltage Vb and a positive high voltage Vc are applied to central cylindrical electrodes E3 of the first electrostatic lens 9a and the second electrostatic lens 9b from the second high voltage power supply 22b and the third high voltage power supply 22c, respectively. In the first electrostatic lens 9a and the second electrostatic lens 9b, the positive high voltage Vb and the positive high voltage Vc are applied to only each of the central cylindrical electrodes E3 of the first electrostatic lens 9a and the second electrostatic lens 9b through the high voltage introduction flanges 20b and 20c that are attached with the vacuum vessel 2. Note that the high voltage introduction flanges 20a, 20b and 20c are fixed to the vacuum vessel 2 through an insulating glass 10a.

The permanent magnet type magnet 21 is provided between the electrostatic lens 9a and the electrostatic lens 9b in the transport system. The permanent magnet type magnet 21 deflects and removes monoatomic or monomolecular singly charged ions (hereinafter referred to monomer ions) included in the gas cluster ion beam 11.

The irradiated substrate 15 is attached to the stage for the irradiated substrate 14 in the vacuum vessel for an irradiation chamber 12, then the irradiation of the gas cluster ion beam 11 is performed onto the irradiated substrate 15. The Faraday cup 13 measures the current value of the gas cluster ion beam 11. The Faraday cup current which is measured by the Faraday cup is measured by an ammeter (not illustrated) which is placed outside of the vacuum vessel for an irradiation chamber 12 through an electric cable. When the current value is measured, the stage for the irradiated substrate 14 moves to a position where the direction of the Faraday cup 13 and the Faraday cup 13 is moved to a position where the axis line of the Faraday cup 13 and the axis line of the gas cluster ion beam 11 coincide with each other, and the measurement of the current value of the gas cluster ion beam 11 is performed. In FIG. 1, the energy (eV) of the gas cluster ion beam 11 that is irradiated onto the irradiate substrate 15 at ground potential is the value of the voltage (Va, several kV to several tens of kV) which is applied to the ionizer multiplied by the ions valance (usually singly charged). However, when the gas cluster ion beam 11 is irradiated onto the irradiated substrate 15, atoms or molecules that constitute the gas cluster ion beam 11 break apart, spread in the surface direction and etch on the irradiated substrate 15, causing so-called lateral sputtering phenomenon. The average energy per one atom or one molecule that is formed by dissociation of the gas cluster ion beam 11 is the value of the above-mentioned energy of the gas cluster ion beam divided by the cluster size (number), and is the value in the range of several eV to several tens of eV (several V to several tens of V in voltage conversion). Therefore, the apparatus for the present embodiment can perform surface processing that causes less damage to a surface structure of the irradiated substrate 15, compared to a general-purpose ion beam processing apparatus (referred to the Patent Document 4) that performs surface processing by accelerating singly charged ions to several kV. Furthermore, in case of substrate processing (etching, etc.) using the beam of a typical ion beam processing apparatus, processing in the vertical direction on the surface of the substrate is mainly performed. In the case of the processing using the gas cluster ion beam to be compared with the above-mentioned processing, since utilizing the feature of the so-called lateral sputtering phenomenon that atoms or molecules broken apart, spread in the horizontal surface direction and etch on the irradiated substrate 15 as mentioned above, the processing has an advantage of achieving the excellent trimming processing for surface flattering.

Note that it must be required to extract ions directly from the ion source at a voltage of several volts to several tens of volts that corresponds to the energy of the ions, in order to obtain a beam of several eV to several tens of eV per one ion using a general-purpose ion beam processing apparatus that uses singly charged ions. In case of a general-purpose ion beam processing apparatus, the ion source, generally, that extracts ions from a plasma source are used. However, since the extraction voltage is sufficient with such a low voltage, the plasma is merely ejected without forming an ion beam. Therefore, a high-current ion beam cannot be extracted by the acceleration voltage of several volts to several tens of volts per one atom that is obtained by the GCIB extraction. Note in the case that the switching of the beam extraction by turning on and off the extraction voltage of about several kV or less generated from the ion source explained above is performed, in general, it is difficult for starting-up the beam of a predetermined current value to perform in a short time of millisecond or less as a starting-up time. This is because enough time is consumed by which the stable plasma boundary suitable for a beam (beam generating boundary) is formed. In addition, it also has the disadvantage of being prone to causing abnormal discharge since the beam strikes the extraction electrode in a forming process of the plasma boundary in an extraction space while the beam is in starting-up. Therefore, in case of the conventional ion source disclosed in the Patent Document 4, it was difficult to perform the extraction by a high-speed switching of a beam of millisecond or less.

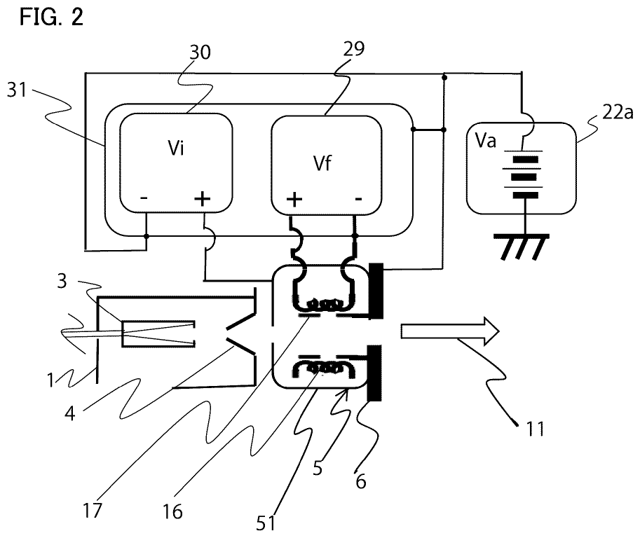

FIG. 2 is a diagram used to explain a power supply configuration of the hot filament power supply 29 and the ionizing power supply 30 for accelerating ionizing thermal electrons in the ionizer 5 of the conventional gas cluster ion beam apparatus illustrated in FIG. 1. The hot filament power supply 29 and the ionizing power supply 30 are stored in a high voltage stage (a red box) 31 that is at same potential as the accelerating electrode 6 to which the high voltage power supply 22a applies a voltage. The high voltage power supply 31 that is a box type member composed from a conductive material can maintain a member, equipment, a power supply, etc. stored in the box at a stable high voltage. Ionizing thermal electrons are generated from the thermal filament 16 heated by the hot filament power supply 29. The generated ionizing thermal elements are accelerated toward the anode rod 17 to which a positive voltage is applied from the ionizing power supply 30 and go forward to a center portion of a conductive housing 51 of the ionizer 5. A cluster beam formed by the nozzle 3 approaches the center portion of the conductive housing 51 of the ionizer 5 through the skimmer 4 and is extracted as the gas cluster ion beam 11 ionized by colliding with thermal ions. In power supplying at a conventional ionizer, the gas cluster ion beam 11 is extracted as a DC beam since a DC power supply is used for all power supply.

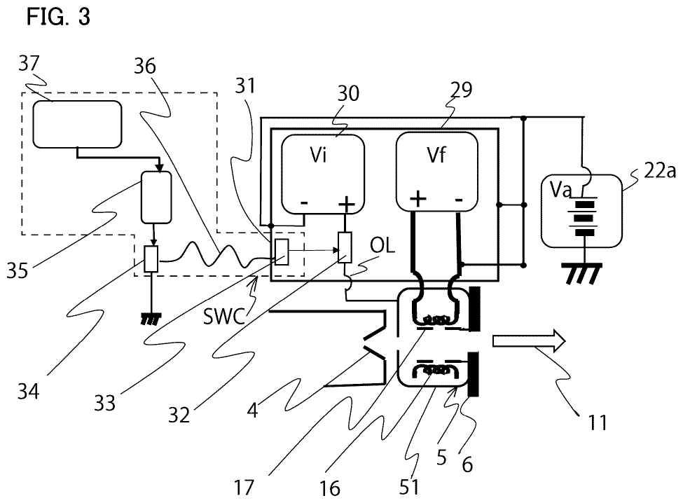

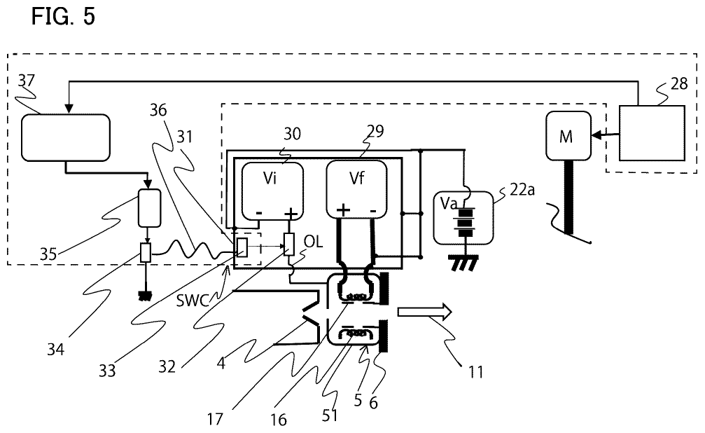

FIG. 3 is a diagram used to explain the configuration of a switching circuit SWC used in the present embodiment for the gas cluster ion beam apparatus of the present invention having a switching function. FIG. 5 is also a diagram illustrating a configuration of the apparatus including the switching circuit SWC used for practically trimming an irradiated substrate by using the gas cluster ion beam apparatus. An embodiment of the gas cluster ion beam apparatus of the present invention is configured by adopting the configuration illustrated in FIG. 3 to the configuration illustrated in FIG. 1. In the configuration illustrated in FIG. 3 and FIG. 5, the hot filament power supply 29 supplying a current to heat the hot filament 16, the ionizing power supply 30 applying an electron acceleration voltage Vi to the anode rod 17 to which a positive high voltage Va is applied, and the high voltage FET 32 as a switching device arranged in an output line OL provided from the ionizing power supply 30 to the conductive housing 51 of the ionizer 5 are arranged in the high voltage stage 31. In the configuration explained above, the positive high voltage Va generated from the high voltage power supply 22a is applied to an output negative terminal (−) of the hot filament power supply 29, an output negative terminal (−) of the ionizing power supply 30 and the high voltage stage 31. The hot filament 16 is connected between the output negative terminal (−) and an output positive terminal (+) of the hot filament power supply 29. In addition, an output positive terminal (+) of the ionizing power supply 30 is connected to the conductive housing 51 of the ionizer 5 through the high voltage FET 32. Furthermore, a high voltage obtained by adding an electron acceleration voltage Vi to a positive high voltage Va is applied to the acceleration electrode 6 and the anode rod 7 electrically coupled to the conductive housing 51 only when the high voltage FET 32 is in an ON state. For example, if the high voltage is 60 kV and the electron acceleration voltage Vi is 500 V, the electron acceleration voltage Vi of 500 V is applied between the hot filament 16 and the anode rod 17 so that the voltage switched by the high voltage FET 32 is the electron acceleration voltage Vi of 500 V. Therefore, the electron acceleration voltage Vi is lower voltage (a voltage of 1/100 or less in the present embodiment level) compared to the voltage of positive high voltage. Therefore, the switching device 32 can be switched with high speed since a general-purpose semiconductor switching device can be used. As a result, according to the present invention, a pulsed beam with short rise and fall times can be stably obtained.

In addition, the ROSA as an optical receiver member for supplying a control signal to the high voltage the FET 32 explained above is arranged in the high voltage stage 31. As already known, the ROSA is a generic name for a package in which a photodiode (PD), optical interface and electrical interface are included. The ROSA 33 safety and stably can accept an optical signal from the TOSA 34 at a ground potential since a high voltage is cut off by an optical cable 36 that is an electrical insulator. As already known, the TOSA is a generic name for a package in which a Laser diode (LD) and driver, optical interface and electrical interface are included. In addition, an optical signal pulse (an optical switching pulse) from the TOSA 34 is generated by a switching pulse signal from a general-purpose pulse generator 35. According to the configuration illustrated in FIG. 3, any waved switching pulse from the pulse generator 35 to the high voltage FET 32 positioned in the high voltage stage 31 can be sent as a stable signal.

Note that in an example illustrated in FIG. 3 and FIG. 5, the switching circuit SWC comprises the high voltage FET 32 as the switching device 32 arranged in the output line OL as a power supply line supplying a voltage to the ionizer 5 and the anode rod 17 with equal potential to the ionizer 5 from the ionizing power supply 30, the ROSA 33 as the optical receiver member, the TOSA 34 as the optical transmitter member, the pulse generator 35, the optical cable 36, a motor drive controller 28 illustrated in FIG. 1 and a pulse generator controller 37. Note that the pulse generator controller 37 receives a signal from the motor drive controller 28 as input and controls the pulse generator 35 so as to generate a rectangular pulse that controls the turning on and off of the switching device 32 depending on the position and moving speed of the irradiated substrate 15 relative to the gas cluster ion beam. The gas cluster ion beam can be intermittently irradiated onto the irradiated substrate 15 by which the switching circuit SWC controls turning on and off of the switching device 32 composed from the high voltage FET.

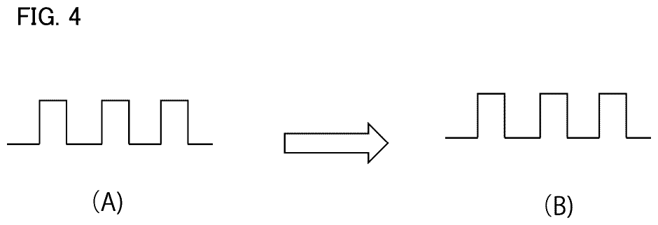

FIG. 4 is a diagram illustrating a switching waveform (A) sent from the pulse generator 35 and a current waveform (B) of the gas cluster ion beam obtained by the Faraday cup 13 practically positioned in the irradiated chamber relative to the configuration of the switching circuit illustrated in FIG. 3. Note that the current waveform (B) of the gas cluster ion beam is measured by an oscilloscope and a pulsed beam current waveform following the switching waveform is obtained. In the above-mentioned situation, a gas type was argon gas and the voltage of positive high voltage generated from the high voltage power supply 22a was 60 kV. In the current waveform (B) of the gas cluster ion beam, rise and fall times are measured and it is confirmed that the rise and fall times are millisecond or less. Note that the electron acceleration voltage (an ionizing DC voltage) Vi further supplied to the positive high voltage Va from the ionizing power supply 30 is about the range of 100-500 V during measurement and it can be confirmed that the electron acceleration voltage (an ionizing DC voltage) Vi was matched with the phase and the waveform (A) illustrated in FIG. 4 over the entire ionization voltage range. Note that the height of the beam pulse waveform (B) of the beam pulse of the gas cluster ion beam illustrated in FIG. 4 becomes high since beam current outputted from the ionizer 5 becomes much when the electron acceleration voltage (an ionizing DC voltage) is high.

FIG. 5 is a diagram illustrating a configuration of the apparatus including the switching circuit SWC used for practically trimming an irradiated substrate by using the gas cluster ion beam apparatus having the switching circuit SWC of the present embodiment. In the motor drive controller 28 for mechanically controlling the irradiated substrate 15 as a sample substrate in a vacuum, data for a scanning speed relative to a sample position are included in correspondence with a measurement result of film thickness distribution on the irradiated substrate 15. The motor drive controller 28 sends signals to the pulse generator controller 37, the signals including the sample position and the scanning speed for turning the irradiation beam on and off in response to the scan speed data. The pulse from the pulse generator 35 is sent to the TOSA 34 by the signal from the pulse generator controller 37, thereby the optical switching signal is sent to the ROSA 33. As a result, the pulsing of the irradiation beam and the switching function of the switching circuit in conjunction with the mechanical scanning of the stage are obtained.

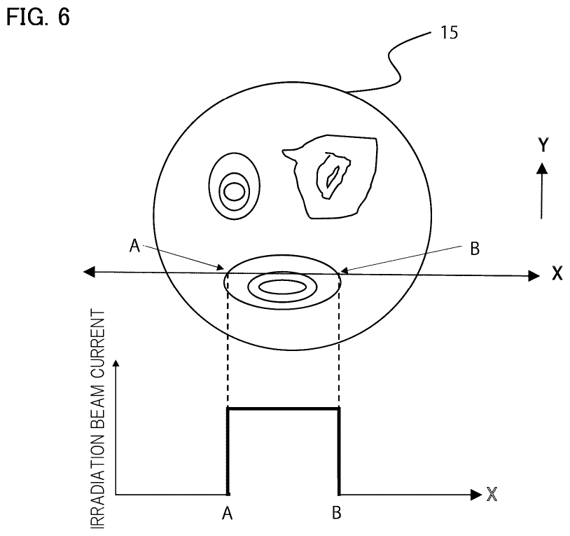

FIG. 6 is a diagram used to explain the relationship between the film thickness distribution position and the beam current of the irradiation beam, when performing the film thickness distribution adjustment for a thermal oxide film on a silicon sample substrate (an irradiated substrate) by using the gas cluster ion beam apparatus including the switching circuit SWC illustrated in FIG. 5. As a gas type, other than Ar, SF₆, NF₃, Cl, etc. can be used. The energy at that time was 30 to 60 keV. In FIG. 6, the film thickness is illustrated as a contour. It is assumed that the film is thick at the region where being illustrated by the contour and a desired thin film thickness has been already obtained at the region without contour. The film thickness is getting thicker toward the center portion of the contour. In FIG. 6, the beam irradiation is performed only on the region between point A and point B where the film is thick relative to the movement of which the sample moves to a lateral direction (the X-axis line direction illustrated in FIG. 6). While irradiating a beam, the stage movement speed of the substrate is varied depending on the thickness distribution so that uniform film thickness can be performed. The uniform film thickness distribution is obtained by which such irradiation is performed by moving in the X direction at positions spaced apart in the Y direction in the figure. Note that in the case that the film is thicker than the desired film thickness in addition to the region where being surrounded by the contour, beam irradiation (DC beam) of a specific irradiation region is performed only in the region other than the region where being surrounded by the contour by the same method as illustrated in FIG. 6 after the region where being surrounded by the contour is adjusted to a desired film thickness.

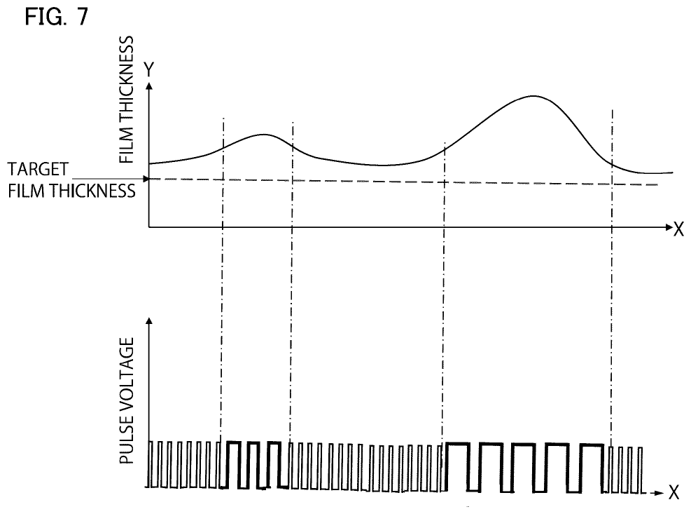

FIG. 7 is a diagram used to explain an example of the irradiation to be performed based on the embodiment of the present invention. In the embodiment illustrated in FIG. 7, pulse irradiation was performed over the entire surface of the silicon sample substrate (an irradiated substrate) with respect to the thickness distribution of the thermal oxide film in the X direction at a certain position in the Y axis direction of the silicon sample substrate. The pulse generator 35 was activated so as to obtain a repeated beam pulse having constant width as an irradiation in a designated section. In addition, then, the width of the beam pulse was varied depending on the film thickness distribution and the value of the film thickness. In particular, an irradiation was performed repeatedly with beam pulses having a long pulse width at the region where the film is thick and an irradiation was performed repeatedly with beam pulses having a short pulse width at the region where the film is thin. The irradiation performed in the example illustrated in FIG. 7 is pulse width modulation (PWM) being able to adjust pulse width and pulse intervals depending on film thickness. In the irradiation explained above, in a region with a thick film thickness, the integrated value of the width of the peak value of the beam pulse becomes large, resulting in a thicker trimming removable. In the present embodiment, in the movement of the stage for an irradiated substrate 14, it has been confirmed that uniform film thickness could be obtained both in dwell time control, when the scanning speed is varied depending on film thickness, and in constant time control, where the film is scanned at a fixed constant speed. Note that adjustment controlling of the pulse width is performed by the pulse generator controller 37.

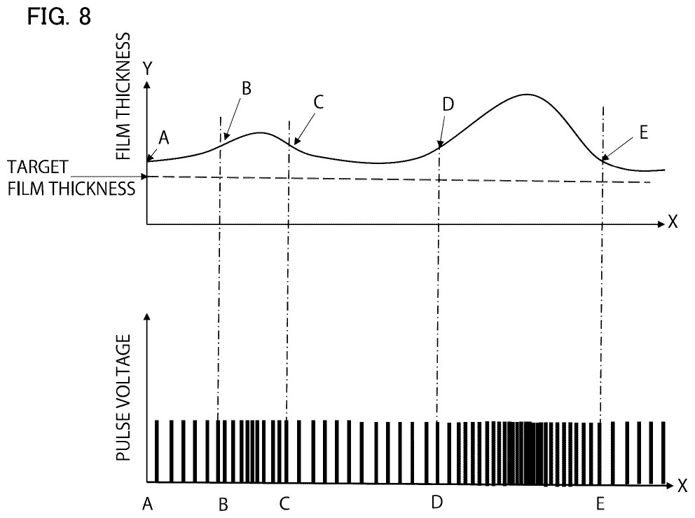

FIG. 8 is a diagram used to explain another example of the irradiation to be performed based on the embodiment of the present invention. In another example illustrated in FIG. 8, a pulse signal having a fixed width was continuously introduced into the switching circuit SWC and the irradiation was performed by an irradiation beam with a continuous pulse. In addition, the pulse cycle (pulse interval) was varied based on a film thickness of the thermal oxide film. The frequency of the pulse signal generation was modulated (PCM: frequency modulation) based on the film thickness so that the frequency of the pulse generation is low at the regions between point A and point B, between point C and point D and at point E all where the film is thin, and so that the frequency of the pulse generation is high at the regions between point B and point C, between point D and point E both where the film is thick. The frequency modulator was included in the pulse generator controller 37. According to the present embodiment, high accuracy adjustment can be performed for the film thickness of micron meter or less level in the region where the sample is more detailed.

In the embodiments illustrated in FIG. 7 and FIG. 8, it was described that film thickness uniformity was highly accurately obtained for the thermal oxide film formed mainly on a silicon sample substrate. However, it is clear that the present invention is useful even if adjusting the film thickness distribution to any shape. In addition, it is clear from the nature of the present invention that the present invention is also useful even if adjusting the thickness of a film [For example, LT (lithium tantalum oxide film, etc.)] other than the silicon thermal oxide film.

In the present embodiment, a beam of 30 through 60 kV is used as a beam voltage, but it is clear from the nature of the present invention that the present invention can be adopted to adjust a film thickness distribution for a cluster ion beam of less than 30 kV.

### Features of the Embodiments

In the present embodiment, the switching device 32 provided at the output line OL and the switching device 32 switches the output voltage from the ionizing power supply 30 to the ionizer that ionizes a gas cluster ion beam, a controlling pulse signal is sent to the switching device 35, and the gas cluster ion beam can be intermittently irradiated onto the irradiated substrate 15. Consequently, since the gas cluster ion beam extracted from the ionizer 5 is intermittently generated, the extracted beam is also intermittent and the irradiated beam can be pulsed. In addition, since the voltage that is actually switched is lower than the voltage from the high voltage power supply, stable switching is possible. As a result, the rise and fall times of the high-voltage FET 32 are less than a millisecond, enabling high-speed switching of the ionization voltage. Consequently, the extracted ion beam can be also formed as a short rise and fall times pulse beam. Therefore, the switching of the beam can be optionally switched on the way of scanning of the irradiated substrate and the film thickness of the irradiated substrate irradiated by a beam can be highly accurately controlled.

According to the present embodiment, when the trimming (etching) of the film formed on a silicon substrate or the like for adjustment of film thickness is performed with low damage and high speed, the film thickness distribution in the irradiated substrate can be highly accurately adjusted by pulsing a gas cluster ion beam. Especially in recent years, since it has been required that the film thickness of the silicon thermal oxide film is highly accurately adjusted for the frequency adjustment of SAW device (Surface Acoustic Wave), the gas cluster ion beam apparatus of the present invention enables high-speed frequency adjustment in line with practical applications.

While the preferred embodiments of the invention have been described with a certain degree of particularity with reference to the drawings, obvious modifications and variations are possible in light of the above teachings. It is therefore to be understood that within the scope of the appended claims, the invention may be practiced other than as specifically described.

### INDUSTRIAL CAPABILITY

According to the present invention, when generating a DC gas cluster ion beam extracted from the ionizer 5 using the extraction electrode 7, the electron acceleration voltage Vi applied from the ionizing power supply 30 arranged in the high voltage stage 31 to the anode rod 17 positioned in the ionizer 5 is pulsed by which the switching device 32 arranged in the high voltage stage 31 is turned on and off. Although it was technically and practically difficult to switch the beam current by switching the positive high voltage (60 kV), the switching device 32 can be easily switched with fast speed because the voltage of the electron acceleration voltage Vi is lower than the voltage of the positive high voltage, and a pulsed beam of which the rise and fall times are short can be stably obtained. As a result, according to the present invention, unprecedented high accuracy trimming processing by generating a high speed and high accuracy GCIB pulsed beam and adjusting a pulse width and a pulse cycle etc. thereof can be performed.

We claim:

1. A gas cluster ion beam apparatus comprising:
a high voltage power supply that generates a positive high voltage,
a cluster generation chamber that generates a neutral gas cluster beam of gas atoms or gas molecules by injecting high-pressure gas through a nozzle in a vacuum,
a skimmer that skims a cluster beam from a central region in the neutral gas cluster beam,
an ionizer that includes a thermal filament generating ionizing thermal electrons and an anode rod to which an electron acceleration voltage is applied to accelerate the ionizing thermal electrons in a conductive housing to which the positive high voltage is applied, and generates cluster ions by impacting ionization of the ionizing thermal electrons to be accelerated with the cluster beam introduced into the conductive housing through the skimmer,
a beam transport system that extracts the cluster ions from the ionizer as a gas cluster ion beam by a potential difference between an acceleration electrode provided at an outlet of the conductive housing and to which the positive high voltage is applied and an extraction electrode provided downstream of the acceleration electrode, and irradiates the gas cluster ion beam onto an irradiated substrate placed in a vacuum vessel for an irradiation chamber through one or more electrostatic lenses to which the positive high voltage is applied from the high voltage power supply,
a high voltage stage being in a state to which the positive high voltage is applied and including a thermal filament power supply that supplies a heating current to the thermal filament and an ionizing power supply that applies the electron acceleration voltage to the anode rod to which the positive high voltage is applied, and
a switching circuit (SWC) including a switching device provided in a power supply line between the ionizing power supply and the anode rod,
wherein the gas cluster ion beam can be intermittently irradiated onto the irradiated substrate by which the switching circuit controls the switching device to be turned on and off.

2. The gas cluster ion beam apparatus according to claim 1,
wherein the switching device includes a high voltage FET connected to an output line of the ionizing power supply, and
wherein the switching circuit includes a transmitting and receiving module comprising an optical receiver member and an optical transmitter member connected by an optical fiber, the transmitting and receiving module being provided between a pulse generator that generates on/off pulse signals and the switching device.

3. The gas cluster ion beam apparatus according to claim 2, wherein:
the optical receiver member comprises ROSA, and the optical transmitter member comprises TOSA.

4. The gas cluster ion beam apparatus according to claim 1, wherein:
the switching circuit further includes a pulse generator that generates square pulses to control the switching device to be turned on and off,
a motor drive controller that drives and controls a motor that drives a stage for an irradiated substrate mounting the irradiated substrate, and
a pulse generator controller that controls output timing of the pulses output from the pulse generator based on both position and mechanical movement speed of the irradiated substrate obtained by the motor drive controller,
wherein the pulse generator controller controls the pulse generator so as to generate the square pulses that control the switching device depending on both the position and the movement speed of the irradiated substrate relative to the gas cluster ion beam, by using signal a signal transmitted from the motor drive controller as an input.

5. The gas cluster ion beam apparatus according to claim 4, wherein:
the pulse generator controller controls the pulse generator so as to obtain any film thickness distribution by which the gas cluster ion beam irradiates only to a specified film thickness region with the movement of the irradiated substrate when the film thickness distribution is adjusted by removing the film by irradiating the gas cluster ion beam after measuring the film thickness distribution of the irradiated substrate on which a film made of a material different from the film of the substrate has been deposited.

6. The gas cluster ion beam apparatus according to claim 4,
wherein the pulse generator is configured to generate square pulses, and
wherein the pulse generator controller changes a pulse width and a pulse interval of square gas cluster ion beam pulses generated by the square pulses depending on the position and velocity of the irradiated substrate as the irradiated substrate is mechanically moved, thereby making it possible to adjust the film thickness distribution of the irradiated substrate to any shape.

7. The gas cluster ion beam apparatus according to claim 6, wherein:
the pulse generator controller obtains a purposed film thickness distribution by which a frequency of repetitive pulses is modulated in proportion to the thickness of the film with the movement of the irradiated substrate.

8. The gas cluster ion beam apparatus according to claim 1, wherein:
the irradiated substrate is mechanically moved with constant velocity.

9. The gas cluster ion beam apparatus according to claim 1, wherein:
the mechanical movement speed of the irradiated substrate is change depending on a position and a film thickness on the irradiated substrate.
